(19) United States
(12) Patent Application Publication
(10) Pub. No.: US 2025/0163246 A1
(43) Pub. Date: May 22, 2025

(54) ITEM MADE OF A MINERAL COMPOSITE MATERIAL AND METHOD FOR MANUFACTURING SAME

(71) Applicant: The Swatch Group Research and Development Ltd, Marin (CH)

(72) Inventors: Nicolas François, Neuchâtel (CH); Marek Dovcik, Mougins (FR); Sophie Napoli, Neuchâtel (CH); Stewes Bourban, Chabrey (CH)

(73) Assignee: The Swatch Group Research and Development Ltd, Marin (CH)

(21) Appl. No.: 18/817,439

(22) Filed: Aug. 28, 2024

(30) Foreign Application Priority Data
Nov. 20, 2023 (KR) 23210794.6

(51) Int. Cl. C08K 9/02; C08J 3/20; C08K 3/26

(52) U.S. Cl. CPC C08K 9/02; C08J 3/203; C08K 3/26; C08K 2003/265; C08K 2201/005

(57) ABSTRACT

An item made of a composite material comprising by weight: one or more thermoplastic resins that are at least partially biobased, the total percentage of the one or more thermoplastic resins being between 20% and 74.9%; a mineral filler with a seashell-based mineral material and a porous silica-based mineral material derived from diatom skeletons, the percentage of the mineral filler being between 25% and 79.9%; a dispersant, the percentage by weight whereof being between 0.1% and 5%, preferably between 0.1% and 1%; optionally a stain system, the percentage whereof being between 0% and 5%; optionally a reinforcement, the percentage whereof being between 0% and 8%; and optionally a coupling agent, the percentage whereof being between 0% and 5%.

### CROSS-REFERENCE TO RELATED APPLICATIONS

This application claims priority to European Patent Application No. 23210794.6 filed Nov. 20, 2023, the entire contents of which are incorporated herein by reference.

### TECHNICAL FIELD OF THE INVENTION

The invention relates to a composite material comprising at least one biobased resin and a mineral filler.

### TECHNOLOGICAL BACKGROUND

So-called bioceramic materials are known in the prior art. These involve mixing a partially biobased resin, such as Polyamide 11 that is more than 50% biobased, with a ceramic such as yttria-stabilised zirconia (YSZ). The known advantages of such a composite are:
Its colourability using conventional stain systems,
The increased density of moulded components due to the inherent density of zirconia, which is 4.5 g/cm³,
An increase in the thermal conductivity of moulded components due to the inherent thermal conductivity of zirconia, which is 2.5 W·m⁻¹·K⁻¹.

Drawbacks of this bioceramic material concern the use of a large proportion of fossil resources in the resin and ceramic, and the potential development of unpleasant odours due to the bacteria that form on the surface of the material when it is worn, and which feed on the organic residues. This is because the materials present in the composite described have no significant antibacterial activity.

### SUMMARY OF THE INVENTION

The invention consists of developing a novel mineral composite material to overcome the drawbacks of the bioceramic material of the prior art. This novel material must have the lowest possible ecological impact, be optimised for comfort when in contact with the skin, allowing heat to be dissipated at the skin-wrist interface, and be anti-odour.

The composite material includes one or more thermoplastic resins that are at least partially biobased. The term ‘partially’ is understood to mean that the one or more resins are, as a whole, biobased at more than or equal to 60%, preferably at more than or equal to 85%, more preferably at more than or equal to 98%. In place of the ceramic used in the prior art, the composite material further includes a mineral material derived from seashell, i.e. calcium carbonate (CaCO₃) based, and a porous silica derived from the skeleton of diatoms.

CaCO₃ has a thermal conductivity equivalent to that of YSZ at 2.5 W·m⁻¹·K⁻¹. The density of CaCO₃ is 2.7 g·cm⁻³, compared with 4.5 g·cm⁻³ for zirconia, which makes the composite lighter to wear. Diatomaceous silica has antibacterial properties that prevent the development of unpleasant odours. Moreover, when mixed with seashell, it improves the flow of powder in the dispenser during the manufacturing process.

More specifically, the invention relates to an item made of a composite material comprising by weight:
one or more thermoplastic resins that are at least partially biobased, the total percentage of the one or more thermoplastic resins being between 20% and 74.9%,
a mineral filler with a seashell-based mineral material and a porous silica-based mineral material derived from diatom skeletons, the percentage of the mineral filler being between 25% and 79.9%,
a dispersant, the percentage whereof being between 0.1% and 5%, preferably between 0.1% and 1%,
optionally a stain system, the percentage whereof being between 0% and 5%,
optionally a reinforcement, the percentage whereof being between 0% and 8%,
optionally a coupling agent, the percentage whereof being between 0% and 5%.

It further relates to the method for manufacturing the item, which method includes the following steps of:
a. Providing the seashell-based mineral material and the porous silica-based mineral material derived from diatom skeletons,
b. Providing the one or more thermoplastic resins that are at least partially biobased,
c. Collecting, sorting, cleaning, crushing and sieving the seashell to retain only seashell particles with a particle size of 100 μm or less,
d. Mixing the seashell particles and porous silica, the mixture forming the mineral filler,
e. Mixing the mineral filler and the one or more thermoplastic resins with the dispersant,
f. Optionally adding the stain system, reinforcement and/or coupling agent to the mixture obtained in step e.,
g. Shaping the mixture obtained in step e. or in step f. to obtain the item.

### DETAILED DESCRIPTION OF THE INVENTION

The invention relates to an item made of a composite material including at least one predominantly biobased thermoplastic resin and a calcium carbonate and porous silica-based mineral material. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial, a hand and a dial index.

The composite material comprises (or consists of), based on the total weight of the composite:
one or more thermoplastic resins, the total percentage by weight whereof is between 20% and 74.9%, preferably between 50% and 59.9%. The resin mixture, or the resin if there is a single resin, is biobased at more than or equal to 60%, preferably more than or equal to 85%, more preferably more than or equal to 98%; the biobased percentage of the mixture or of the resin being measured in accordance with standard ASTM D6866-22. The one or more thermoplastic resins are chosen from polyamide 11 (PA11), polyamide 10 (PA10), polyamide 610 (PA610), polyethylene furanoate (PEF), polyurethane (PU), polyether block amide (PEBA), thermoplastic copolyester elastomer (TPC), thermoplastic polyurethane elastomer (TPU), thermoplastic polyolefin elastomer (TPO), thermoplastic vulcanised elastomer (TPV) and thermoplastic styrene elastomer (TPES). The composite material can be flexible or rigid. In the case of a rigid composite, the mixture can include a thermoplastic resin chosen from polyamide 11 (PA11), polyamide 10 (PA10), polyamide 610 (PA610) and polyethylene furanoate (PEF) and a thermoplastic elastomer resin of the polyurethane (PU) or polyether block amide (PEBA) type to absorb impacts. The thermoplastic elastomer resin is thus present in a percentage by weight based on the total weight of the resin mixture of between 1 and 10%. The rigid composite could comprise several grades of the same type of thermoelastic resin and of the same type of thermoplastic elastomer resin, for example several PA11 resins with different rheologies. Preferably, the PA11, PA10 and PEF resins are 98% biobased, the PA610 resin is 62% biobased and the thermoplastic elastomer resin is more than 40% biobased, more preferably 98%. In the case of a flexible composite, only flexible thermoplastic elastomer resins are used. This can be a composite including a resin chosen from PEBA (polyether block amide), TPC (thermoplastic copolyester elastomer), TPU (thermoplastic polyurethane elastomer), TPO (thermoplastic polyolefin elastomer), TPV (thermoplastic vulcanised elastomer) and TPES (thermoplastic styrene elastomer). As mentioned above, it can be a resin that includes several grades for this type of resin, thus with different rheologies. Preferably, it is a resin or a mixture of the same type of resin chosen from TPU, TPC and PEBA,
a mineral filler comprising a calcium carbonate (CaCO₃) based mineral material and a porous silica-based mineral material, the total percentage by weight whereof is between 25% and 79.9%, preferably between 40% and 49.9%. The CaCO₃-based mineral material is derived from shellfish and more precisely from shellfish production waste. Preferably, these are scallops and/or oyster shells because of their lighter natural colour. They are present with a particle size of less than or equal to 100 μm, preferably less than or equal to 20 μm, the particle size being measured using a laser diffractometry method (ISO 13320-1 (2009)). The porous silica is derived from diatom skeletons. These are microalgae that are unicellular organisms with a silica skeleton. The porous silica in diatom skeletons is farmed and is thus renewable. The porous silica is present in a percentage by weight of between 2% and 20% of the total weight of the mineral filler. The microporous silica can be doped with silver ions or another antibacterial additive such as gold microparticles or copper oxide microparticles in order to increase its antibacterial effect tenfold.
a dispersant, the percentage by weight whereof is between 0.1 and 5%, preferably between 0.1 and 1%. This can be a natural wax, paraffins, surfactants, etc.
optionally, a stain system, the percentage by weight whereof is between 0% and 5%. For example, the stain system can be formed from one or more biobased resins concentrated in natural colouring materials, such as a PA11 resin or a PA10 resin. Optionally, the stain system can contain a mineral material derived from seashell with a size fraction or combination of different size fractions, taken by sieving; the average size of these different fractions being higher and between 100 and 500 μm. This makes it possible to visualise the seashell grains when a particular aesthetic effect is sought. The mineral material can be the scallop and oyster shells mentioned above, or other types of shellfish such as mussels, in which case the larger particles are selected. The percentage of this mineral material in the stain system can be between 1% and 10%, or between 0% and 0.3% based on the total weight for the upper limit of 10%.
optionally, a reinforcement, the percentage by weight whereof is between 0% and 8%. The reinforcement can be present in various forms, for example in the form of fibres or particles. For example, it can be metallic, mineral or organic fibres of plant or non-plant origin. For example, calcium alginate fibres from seaweed could be preferred. Alternatively, carbon fibres, glass fibres, or glass beads, etc. can be used.
optionally, a coupling agent to optimise the interface between the mineral filler, any reinforcements and the resin mixture. This coupling agent can be present in a percentage by weight of between 0% and 5%. For example, it can be a copolymer of ethylene and acrylic acid. It can also be a copolymer of ethylene-vinyl acetate and acrylic acid.

The invention further relates to the method for manufacturing the item described above. It includes the following steps of:
Providing the seashell and porous silica derived from diatom skeletons,
Providing the one or more biobased thermoplastic resins. Preferably, the one or more thermoplastic resins have a melt volume rate of less than 30 cm³/10 min.
Collecting, sorting, cleaning, crushing and sieving seashell to retain particles with a particle size of less than or equal to 100 μm, preferably less than or equal to 20 μm,
Mixing the seashell particles and porous silica, the mixture forming the mineral filler,
Mixing the mineral filler and the one or more thermoplastic resins with the dispersant,
Optionally adding the stain system, reinforcement and/or coupling agent to the mixture derived from the mineral filler, the one or more thermoplastic resins and the dispersant,
Shaping the mixture derived from the mineral filler, the one or more thermoplastic resins and the dispersant with any additions to obtain the item.

Shaping can be carried out by injection moulding after a prior compounding step by twin-screw extrusion and granulation. Alternatively, the manufacturing method could be carried out by extrusion.

Before crushing, the seashell is sorted manually or automatically according to colour. It can be cleaned by physical-chemical washing with a mechanical action such as brushing in a basic solution such as bleach to remove organic matter.

Preferably, different particle sizes of shell particles are mixed to have a wider particle size distribution or a polymodal particle size distribution in order to improve the compactness of the fillers and to be able to fill the system with resins at levels greater than or equal to 40% by weight. For example, it is possible to combine 100% of the fraction sieved at 10 μm, with 50% of the fraction sieved at 20 μm and 10% of the fraction sieved at 100 μm. The fractions with a larger particle size can optionally be recovered for use in the stain system to give the particular aesthetic appearance.

1. An item made of a composite material comprising by weight:
one or more thermoplastic resins that are at least partially biobased, the total percentage of the one or more thermoplastic resins being between 20% and 74.9%,
a mineral filler with a seashell-based mineral material and a porous silica-based mineral material derived from diatom skeletons, the percentage of the mineral filler being between 25% and 79.9%,
a dispersant, the percentage by weight whereof being between 0.1% and 5%, preferably between 0.1% and 1%,
optionally a stain system, the percentage whereof being between 0% and 5%,
optionally a reinforcement, the percentage whereof being between 0% and 8%, and
optionally a coupling agent, the percentage whereof being between 0% and 5%.

2. The item according to claim 1, wherein the one or more thermoplastic resins are, as a whole, biobased at more than or equal to 60%, preferably more than or equal to 85%, more preferably more than or equal to 98%, the rate being measured in accordance with standard ASTM D6866-22.

3. The item according to claim 1, wherein the one or more thermoplastic resins are chosen from polyamide 11, polyamide 10, polyamide 610, polyethylene furanoate, polyurethane, polyether block amide, thermoplastic copolyester elastomer, thermoplastic polyurethane elastomer, thermoplastic polyolefin elastomer, thermoplastic vulcanised elastomer and thermoplastic styrene elastomer.

4. The item according to claim 3, wherein, for a rigid composite material, it includes a thermoplastic resin chosen from a first list consisting of polyamide 11, polyamide 10, polyamide 610 and polyethylene furanoate and a thermoplastic elastomer resin chosen from a second list consisting of polyurethane and polyether block amide, or it includes several resins of the same type chosen from said first and second lists.

5. The item according to claim 3, wherein, for a flexible composite material, it includes a thermoplastic elastomer resin chosen from the list consisting of polyether block amide, thermoplastic copolyester elastomer, thermoplastic polyurethane elastomer, thermoplastic polyolefin elastomer, thermoplastic vulcanised elastomer and thermoplastic styrene elastomer, or it includes several resins of the same type chosen from said list.

6. The item according to claim 1, wherein the percentage by weight of the mineral filler is between 40% and 49.9% and in that the total weight percentage of the one or more thermoplastic resins is between 50% and 59.9%.

7. The item according to claim 1, wherein the porous silica is present in a percentage by weight of between 2% and 20% of the weight of the mineral filler.

8. The item according to claim 1, wherein the porous silica is doped with one or more antibacterial additives.

9. The item according to claim 8, wherein the one or more antibacterial additives are chosen from silver ions, gold microparticles and copper oxide microparticles.

10. The item according to claim 1, wherein the seashell-based mineral material has a particle size of less than or equal to 100 μm, preferably less than or equal to 20 μm.

11. The item according to claim 1, wherein the stain system further includes a seashell-based mineral material, said mineral material having a particle size of between 100 μm and 500 μm.

12. The item according to claim 11, wherein the percentage by weight of the mineral material based on that of the stain system is between 1% and 10%.

13. A method for manufacturing the item according to claim 1, comprising the steps of:
a. Providing the seashell-based mineral material and the porous silica-based mineral material derived from diatom skeletons,
b. Providing the one or more thermoplastic resins that are at least partially biobased,
c. Collecting, sorting, cleaning, crushing and sieving the seashell to retain only seashell particles with a particle size of 100 μm or less,
d. Mixing the seashell particles and porous silica, the mixture forming the mineral filler,
e. Mixing the mineral filler and the one or more thermoplastic resins with the dispersant,
f. Optionally adding the stain system, reinforcement and/or coupling agent to the mixture obtained in step e.,
g. Shaping the mixture obtained in step e. or in step f. to obtain the item.

14. The method according to claim 13, wherein the one or more thermoplastic resins have a melt volume rate of less than 30 cm³/10 min.

15. The method according to claim 13, wherein different sizes of the seashell particles are mixed in step d in order to improve the compactness of the mineral filler.

16. The method according to claim 13, wherein cleaning is carried out before crushing with mechanical action in a basic solution.

17. The method according to claim 13, wherein the shaping step g is carried out by injection moulding or by extrusion.
